(19) United States
(12) Patent Application Publication
(10) Pub. No.: US 2003/0212747 A1
(43) Pub. Date: Nov. 13, 2003

(54) Method for dispatching electronic text messages over a data link

(76) Inventor: Thomas Meyer, Essen (DE)

Correspondence Address: LERNER AND GREENBERG, P.A., POST OFFICE BOX 2480, HOLLYWOOD, FL, 33022-2480, US

(21) Appl. No.: 10/141,680

(22) Filed: May 8, 2002

(51) Int. Cl. G06F 15/16

(52) U.S. Cl. 709/206; 709/207; 709/245

(57) ABSTRACT

Electronic text messages (electronic mail, e-mail) are disseminated over a data link, in particular the Internet or over a telephone network. A status signal for signaling the reception of an electronic message is sent with respect to the message to be transmitted. In order to ensure here that the receiver is informed of the reception of electronic text messages as immediately as possible even if the respective receiver device, i.e. the receiver computer is not switched on or is not online at that particular time, a status signal is transmitted for chronologically characterizing the reception or the directly imminent reception of an electronic text message over a separate transmission path or transmission channel. The status signal is in the form of an automatically generated signal or telephone call and is in a direct chronological relationship with the message which has been sent or which is to be sent.

### BACKGROUND OF THE INVENTION

### Field of the Invention

The invention relates to a method for dispatching electronic text messages (electronic mail, i.e. e-mail) over a data link, in particular the Internet or over a telephone network, a status signal for signaling the reception of an electronic message being sent with respect to the message to be transmitted.

Methods of this type are known as what are referred to as e-mail methods. For this purpose, text messages are written on a computer which is connected to the Internet by means of an appropriate data line or a data channel via the access, for example over the public telephone network. A file which is appropriately created or generated at the receiver end is then dispatched over this data link to an addressee who is provided with a corresponding electronic address. In parallel with the message to be transmitted, status signals for signaling the reception of an electronic message can be sent, something which is generally carried out in such a way that if, in the most favorable case, the same software is being used at both the sender end and the receiver end, a confirmation signal is sent back if the receiver has received and opened, i.e. read, the text message. Moreover, visual, or visually supported audible signals or audibly supported visual signals, may be generated at the respective computer, either characterizing the reception or the confirmation of the reception and reading which can be designated in this way.

Methods of this type are thus commonplace and sufficiently known.

In order to ensure the quickest possible reception of text messages (e-mails) which are sent at a particular time it is necessary for the aforesaid communicating computers also to be switched on, and as it were, online on the network at the same time. However, such a condition can be ensured only by professional operators, and then moreover only at working times which overlap. Generally, what are referred to as mail servers, which intercommunicate between the receivers and senders, are used. This means that they administer e-mail addresses, and thus e-mails which have been received, for respective network customers in a way similar to a mailbox. That is to say incoming mails is stored there if the respective user is not online on the network at that time. The respectively received text messages can then be called later at the aforesaid address or the mail server views the administered mailbox at certain time intervals and issues a brief message to the customer relating to the possible reception of an e-mail.

It is thus the case that the stored text messages are called by the receiver in a way which is determined more or less by chance.

The quickest possible updating is, in turn, only possible if the aforesaid receiver computers are permanently available online.

A further disadvantage of the method mentioned at the beginning is that mail is called only at fixed times.

### SUMMARY OF THE INVENTION

It is accordingly an object of the invention to provide a method for transmitting electronic text messages via a data link, which overcomes the above-mentioned disadvantages of the heretofore-known devices and methods of this general type and which provides information on the reception of electronic text messages as immediately as possible even if the respective receiver device, i.e. the receiver computer, is not switched on or online at that particular time.

With the foregoing and other objects in view there is provided, in accordance with the invention, a message transmission method, which comprises:

dispatching an electronic message (e.g., a text message such an electronic text message or e-mail message) over a data link (e.g., a data link, Internet, telephone network);

automatically generating a status signal (e.g., in the form of an electronic signal or a telephone call) chronologically characterizing a reception or an immediately imminent reception of the electronic message, and transmitting the status signal over a separate transmission path or transmission channel in a direct chronological relationship with the electronic message that has been sent or is to be sent.

In accordance with an added feature of the invention, the status signal is transmitted substantially concurrently with the electronic message.

In accordance with an additional feature of the invention, the method comprises automatically selecting a telephone number of a receiver of the electronic message in a logical and chronological relationship with the electronic message to be sent immediately, and transmitting a brief message or a status signal relating to the aforesaid text message to the receiver over the telephone network.

In accordance with another feature of the invention, the electronic message is administered at a control center and, when an electronic message arrives at the control center, automatically selecting in the control center a stored telephone number of an addressee of the electronic message, and transmitting, over the transmission path, a status signal to the addressee relating to the electronic message that has been received and that is available for download.

In accordance with a further feature of the invention, the receiver is a computer or an electronic text receiver networked between one of the transmission channel and the Internet and a telephone network, and wherein an arrival of a telephone call that characterizes a reception or dispatching of the electronic message is detected at the receiver by a detection code, and a retrieval or calling of the electronic message from a mail server is automatically initiated at the receiver.

In accordance with again an added feature of the invention, the method comprises automatically generating a further status signal with respect to the electronic message that has been called and is locally present at the addressee, and transmitting the further status signal to signal the downloading of the electronic message.

In accordance with again a further feature of the invention, the status signal is further administered technically at the computer of the receiver, and utilizing the status signal technically on a local basis for further measures.

In accordance with again another feature of the invention, the status signal may be sent to one SMS-mode-operated terminal or to a freely selectable number of SMS-mode-operated terminals.

In accordance with a concomitant feature of the invention, after the status signal has been received at a receiver computer, the status signal is supplemented with signals giving an indication of a location or with device-related address indications, and the supplemented status signal is further distributed as a further status signal.

The core of the invention here is that a status signal for chronologically characterizing the reception or the directly imminent reception of an electronic text message is transmitted over a separate transmission path or transmission channel in the form of an automatically generated telephone call, in a direct chronological relationship with the message which has been sent or is to be sent. In this way, a second transmission path or transmission channel is used for a separate electronic message which only announces or gives up-to-date information on the current reception of a text message. The use of a second separate transmission path now makes it possible for the status of a text message received for a receiver to be transmitted directly in a chronological relationship with it and to make the computer at the receiver end immediately call the text message sent for it at a given time even when said computer at the receiver end is switched off, by automatically connecting the computer into the network.

In contrast to the described prior art, in the method according to the invention, the signal which is sent does not merely generate a pop up in the receiver computer when it is switched on, only then indicating the reception of an e-mail, but instead the transmission of the signal according to the invention takes place in real time at the time when the e-mail is sent. Furthermore, in contrast to the described prior art, the signal mode can be passed on, that is to say can thus also be distributed further in computer systems. Furthermore, in contrast to known methods of this type, it is ensured that the e-mail cannot be read at the provider.

The text messages therefore do not remain, for example, in the mail server mailbox, described already at the beginning, until they are retrieved, which retrieval is then determined by cycle times or by chance, but rather the receiver receives a special message which informs him of the reception of a corresponding text message (e-mail) at that particular time. Because a separate transmission path is selected, the receiver-end computer does not, as already described, need to be switched on at that particular time. It is important here that the aforesaid status signal which is to be sent separately is automatically generated in a correspondingly chronological and logical relationship with the aforesaid sent text message.

In a further advantageous refinement there is provision that a telephone number, present at the sender, of the receiver of the text message is automatically selected in a logical and chronological relationship with the sent text message or text message which is to be sent immediately, and a brief message or a status signal relating to the aforesaid text message is sent over the aforesaid telephone network on this channel. It is important here also that the aforesaid telephone call is physically, i.e. electronically, independent of the text message. In this way, this status signal which is configured in this way or the aforesaid brief message is made independent of whether or not the receiver computer is currently online when the brief message or the status signal is received.

In a further advantageous refinement it is stated that when the electronic text messages are used and/or administered by means of a control center (mail server), when a text message arrives at the mail server, the latter automatically selects the stored telephone number of the corresponding addressee and sends, over this transmission path, a status signal to the addressee relating to the text message which has now been received and which is ready to be called. Here, one refinement possibility is equipped with the aforesaid procedure according to the invention wherein the text messages between the sender and receiver pass via a described mail server. The mail server is basically permanently online and has the current data flows and their statuses.

In this way, the corresponding status signal or the brief message relating to the received text message is generated at the mail server and is automatically sent to the receiver, as already described in claim 1, over a separate transmission path. This transmission path can, for example, also be the telephone network, and a telephone call is automatically generated at the receiver in order to inform him immediately of a text message which has been received at a given time.

In a further advantageous refinement there is provision that when a computer or an electronic text receiver is networked with the transmission channel or the Internet on the one hand and the telephone network on the other, the arrival of an aforesaid telephone call which characterizes the reception or the dispatching of an electronic text message can be detected at the receiver end by appropriately adding a detection code, and the start and/or the retrieval or calling of the electronic text message from a mail server or the like is/are thus automatically generated. That is to say in the event that the computer or aforesaid computers or electronic text receiver or receivers is/are connected to the transmission channel or the Internet on the one hand and to the telephone network on the other, the aforesaid incoming telephone call can also be distinguished electronically from another telephone call of the usual type by virtue of the fact that the aforesaid information telephone call for characterizing a received electronic text message can be detected. For this purpose, a detection code is added without the, as it were, manual reception of the telephone call being necessary. That is to say at the receiver end such an information telephone call is electronically detected as coming from the sender directly or from the mail server, and the system which is in the stand-by mode, and is thus not online on the network, is then activated and an online connection is setup automatically and the text message which has been received at that particular time is retrieved. Such systems are suitable for having a continuous chronologically direct connection to the Internet and to incoming text messages without the computer having to be permanently online at the receiver end. In addition to the advantages for a private individual, this also results in considerable cost advantages for a commercial user.

In a further advantageous refinement it is stated that, if appropriate, a further status signal is automatically generated with respect to text messages which have now been called and are present locally at the addressee, and the procedure adopted in turn is that according to the provisions according to claim 1. This refinement relates to the fact that, for example in a commercial application, an electronically generated telephone call which is received in a company in order to provide information on a received electronic text message is read into the computer system there, detected there and the retrieval of the electronic text message is then automatically generated electronically. If this currently “retrieved” text message is then present within the company in the computer system, an information method sequence can also be in turn generated here again, as already described in claim 1. Within the company, in the computer system there a status signal in the form of a telephone call or the transmission of a brief message can be chronologically wherein once more with respect to the received text message in a chronological relationship, i.e. immediately. The respective person can then receive the respective brief message or the status signal at, for example, a fixed telephone or by means of a mobile telephone, in order to be informed of the text message which has been received at that particular time and is personally directed to him. He can then go to the nearest possible location within the company at which he can use a computer to call his text message which has been received for him.

The system can thus be expediently applied both for the private individual and for industrial use. In both cases, correspondingly compatible software which appropriately provides this service must be created and installed.

In a further advantageous refinement it is stated that the status signal is further administered technically at the computer of the addressee, i.e. of the receiver. This means that the incoming text messages are collected locally at a receiver, for example a company, and then appropriately administered, i.e. distributed. Here, corresponding information status signals or brief messages relating to the reception of a text message at a particular time are further distributed. This also results in a situation wherein the status signal for characterizing a received e-mail is sent separately from the actual text message and is thus independent of whether the receiver-end computers are switched on or permanently connected to the network.

In a further advantageous refinement it is stated that the status signal can be applied to one SMS-mode-operated terminal or to a freely selectable number of SMS-mode-operated terminals. This means that a multiplicity of terminals or receiver devices can be used for merely receiving the status signal or a corresponding brief message relating to the information of a received text message. Here, one telephone number or even a plurality of telephone numbers can be used successively, depending on the telephone number at which the aforesaid respective receiver of the text message is available at a particular time.

In a further advantageous refinement it is stated that the incoming status signal is supplemented with location- or device-related address indications at the receiver computer and is then further distributed as a further status signal. This now means that the electronic text messages which have been received and which are administered in a company in the way already described above are further distributed in this way, and that the aforesaid status signal is once more supplemented, extended or modified within the company. As a result, further information, if appropriate even the respective names of relevant receivers, i.e. thus not only coded names, can also be sent on.

Other features which are considered as characteristic for the invention are set forth in the appended claims.

Although the invention is illustrated and described herein as embodied in a method for dispatching electronic text messages over a data link, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram illustrating the method according to the invention;

FIG. 2 is a block diagram illustrating the method with a computer system having a plurality of receiver possibilities and sender possibilities; and

FIG. 3 is a block diagram illustrating the method with a direct data channel between status signal generators.

### DESCRIPTION OF THE PREFERRED EMBODIMENTS

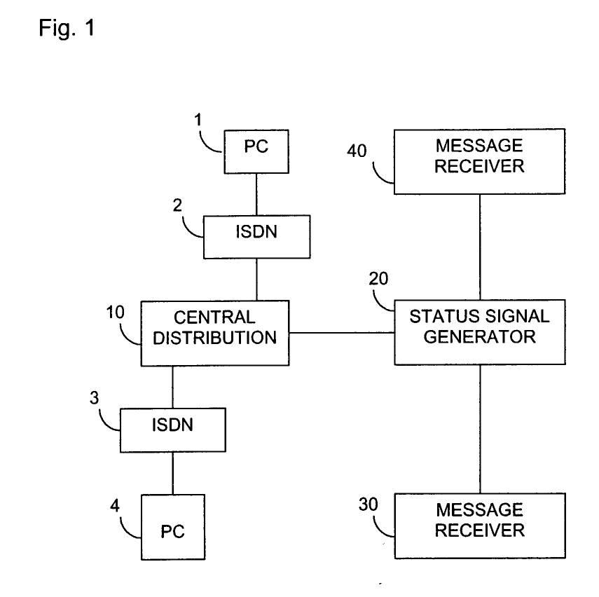

Referring now to the figures of the drawing in detail and first, particularly, to FIG. 1 thereof, there is shown a system implementing the method according to the invention in an easily comprehensible view. A fixed computer 1 is connected to, for example, the Internet by means of an ISDN card 2. The Internet connection is implemented by means of an Internet server or what is referred to as a provider, that is to say a central reception and distribution point 10. A virtual connection is made, for example, between the computer 1 and the computer 4 using this provider. The access to the Internet is also implemented by means of an ISDN card 3 at the receiver end. If an electronic text message is then transmitted by a computer 1 into the Internet by means of the ISDN card 2, said message is received at the provider 10 and is passed on from there to the desired addressee 4. The reception of the aforesaid electronic text message is detected and indicated by means of a status signal generator, and the current reception of an e-mail is signaled without delay to the receiver over a separate transmission channel, for example the telephone network, by means of a corresponding telephone call to the telephone 30 of the receiver. This telephone call can either actually be received, or the item number 30 does not refer to a telephone but rather to a corresponding receiver device which either receives the status signals and informs the receiver in this way or, if appropriate, automatically activates the computer and automatically makes it call the e-mail server. The box 40 similarly indicates a message receiver, which may be used to indicate the delivery of the message, or the delivery of the message that an electronic mail item is available for download. Alternatively, or in addition, the box 40 may simply be a message receiver that corresponds to the receiver 30, for message transmission to the computer 1.

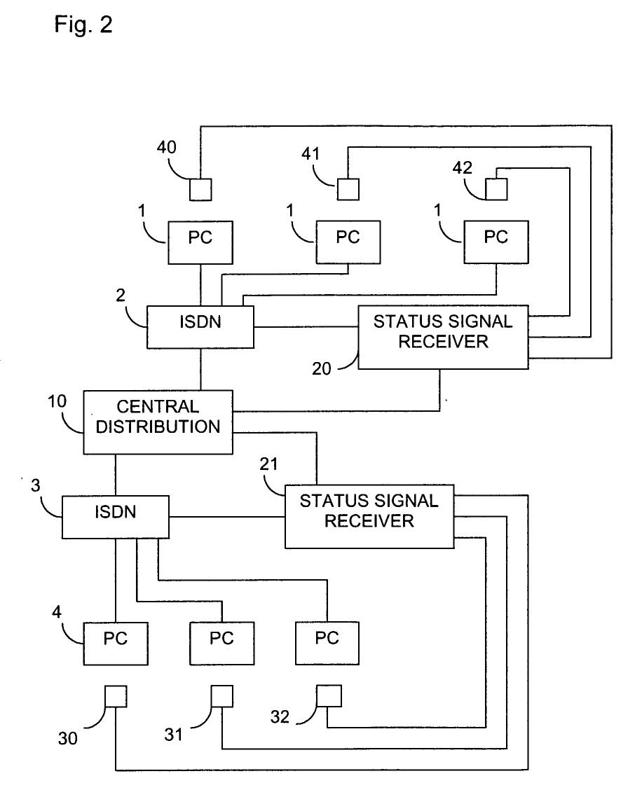

FIG. 2 shows an embodiment wherein a series of individual computers, i.e. a computer system 1, 4, is connected both at the sender end and at the receiver end to an ISDN system 2 or 3. This computer system 1, 4 then accesses the Internet, i.e. also using a provider 10 in this case. In the process, the status signal is generated directly at the provider 10 in this exemplary embodiment and is sent to a status signal receiver 20 or 21 which is respectively arranged at the receiver end and sender end. This status signal receiver 20, 21 detects to which workstation the dispatched electronic text message is precisely addressed and distributes corresponding status signals to the respective workstations, for example by means of a company-internal telephone call to the telephones or receiver devices 30, 31, or 32; 40, 41, or 42, etc..

This info call which is then distributed locally can also be passed on to relatively small radio units such as mobile telephones etc.

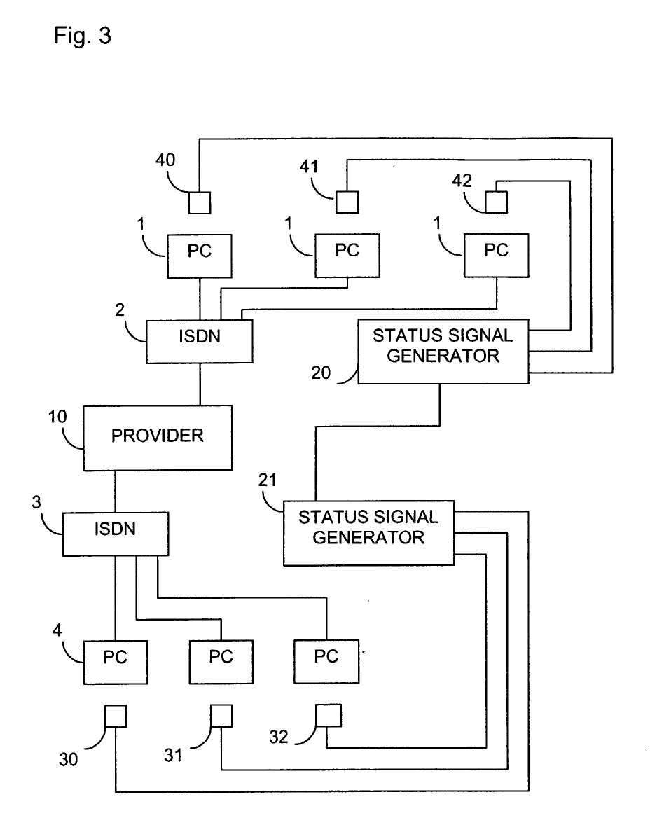

FIG. 3 shows an embodiment wherein a system is selected as in FIG. 2, but the aforesaid status signal generators 20 and 21 at the receiver end and transmitter end communicate with one another completely independently over a separate transmission path. The status signal generators can thus communicate directly with one another without a provider, as a result of which the status signals can also be transmitted over a completely separate transmission path.

I claim:

1. A message transmission method, which comprises:
dispatching an electronic message over a data link;
automatically generating a status signal chronologically characterizing a reception or an immediately imminent reception of the electronic message, and transmitting the status signal over a separate transmission path or transmission channel in a direct chronological relationship with the electronic message that has been sent or is to be sent.

2. The method according to claim 1, wherein the status signal is in a form of an electronic signal or a telephone call.

3. The method according to claim 1, wherein the electronic message is an electronic text message.

4. The method according to claim 1, wherein the electronic message is an e-mail message and the data link is a telephone network.

5. The method according to claim 1, which comprises transmitting the status signal substantially concurrently with the electronic message.

6. The method according to claim 1, which comprises automatically selecting a telephone number of a receiver of the electronic message in a logical and chronological relationship with the electronic message to be sent immediately, and transmitting a brief message or a status signal relating to the aforesaid text message to the receiver over the telephone network.

7. The method according to claim 1, which comprises administering the electronic message at a control center and, when an electronic message arrives at the control center, automatically selecting in the control center a stored telephone number of an addressee of the electronic message, and transmitting, over the transmission path, a status signal to the addressee relating to the electronic message that has been received and that is available for download.

8. The method according to claim 1, wherein the receiver is a computer or an electronic text receiver networked between one of the transmission channel and the Internet and a telephone network, and wherein an arrival of a telephone call that characterizes a reception or dispatching of the electronic message is detected at the receiver by a detection code, and a retrieval or calling of the electronic message from a mail server is automatically initiated at the receiver.

9. The method according to claim 8, which comprises automatically generating a further status signal with respect to the electronic message that has been called and is locally present at the addressee, and transmitting the further status signal to signal the downloading of the electronic message.

10. The method according to claim 1, which comprises further administering the status signal technically at the computer of the receiver, and utilizing the status signal technically on a local basis for further measures.

11. The method according to claim 10, which comprises applying the status signal to one SMS-mode-operated terminal.

12. The method according to claim 10, which comprises applying the status signal to a freely selectable number of SMS-mode-operated terminals.

13. The method according to claim 1, which comprises, after receiving the status signal at a receiver computer, supplementing the status signal with signals giving an indication of a location or with device-related address indications, and further distributing the supplemented status signal as a further status signal.
